(19) United States
(12) Patent Application Publication
(10) Pub. No.: US 2008/0059152 A1
(43) Pub. Date: Mar. 6, 2008

(54) SYSTEM AND METHOD FOR HANDLING JARGON IN COMMUNICATION SYSTEMS

(75) Inventors: Sharon FRIDMAN, London (GB); Tal Rayman, Tel Aviv (IL); Thomas Chambers Ely, Bridgewater, NJ (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: NeuStar, Inc., Sterling, VA (US)

(21) Appl. No.: 11/840,873

(22) Filed: Aug. 17, 2007

Related U.S. Application Data
(60) Provisional application No. 60/838,158, filed on Aug. 17, 2006.

(51) Int. Cl. G06F 17/27

(52) U.S. Cl. 704/9

(57) ABSTRACT

The present invention is directed to a system and method for handling jargon in communication systems. The present invention can allow users and communication systems to manage jargon, providing end users with the ability to translate incoming messages containing unknown words, expressions, symbols, shortcuts, and the like. For example, the present invention can be used in messaging systems to allow unaware or unfamiliar users to be able to easily comprehend messages that include such jargon and shortcuts. Alternatively, users with small screens (e.g., on mobile or handheld communication devices) or for other reasons can receive and/or display jargon or shortcuts automatically where appropriate, instead of long phrases. The present invention can perform such jargon translation on the server side, on the client/recipient side, or in a mixed server/client mode. Any suitable type of messaging or communication system can utilize the jargon handling system of the present invention.

The present application claims priority under 35 U.S.C. §119(e) to U.S. Provisional Application No. 60/838,158, filed on Aug. 17, 2006, the entire contents of which are hereby incorporated by reference herein.

### BACKGROUND

1. Field of the Invention

The present invention relates to communication systems. More particularly, the present invention relates to a system and method for handling jargon in communication systems.

2. Background Information

Communication environments can provide communication messaging services (e.g., instant messaging (IM), e-mail, or the like) through which users can exchange messages. In particular, conventional messaging and chat systems can employ specific internet acronyms, jargon, shortcuts, and the like. For example, Table 1 provides several examples of typical internet jargon that can be used in creating such messages.

TABLE 1
Examples of internet jargon

| INTERNET JARGON | MEANING |
|---|---|
| BRB | Be Right Back |
| BTW | By The Way |
| HHOK | Ha Ha Only Kidding |
| IMHO | In My Humble Opinion |
| TTFN | Ta-Ta For Now |
| TTYL | Talk To You Later |

“Emoticons” or other similar types of symbols and icons can be used to communicate inflection or emotion in messages. For example, “:-)” (i.e., a smiling face) can be used to represent “happy,” while “:-(” (i.e., a frowning face) can be used to represent “sad.”

Such jargon and shortcuts can be used in environments and with user devices (e.g., mobile environments and devices) where limitations in the input or output mechanisms (e.g., small display, small or incomplete keyboard) make the creation or review of long textual phrases inconvenient, burdensome, or otherwise difficult. Additionally, bandwidth used by and allocated to such devices and within such environments may not be conducive to communicating long textual messages, thereby promoting the use of such jargon and shortcuts. However, such jargon and shortcuts may or may not be recognized by all users, thereby creating potential difficulties and disparities in communicating thoughts, ideas, impressions, and other information between parties.

### SUMMARY OF THE INVENTION

A system and method are disclosed for handling jargon in communication systems. In accordance with exemplary embodiments of the present invention, according to a first aspect of the present invention, a system for communicating messages incorporating jargon includes a communication enabler server module in communication with a plurality of user communication modules. A first user communication module is configured to communicate a message incorporating jargon to a second user communication module. The communication enabler server module includes a jargon translation module. The jargon translation module is configured to translate the jargon incorporated into the message in accordance with jargon translation policy associated with at least one of the first and second user communication modules. The communication enabler server module is configured to communicate a jargon translated message to the second user communication module in accordance with the jargon translation policy.

According to the first aspect, the communication enabler server module can include a translation policy management module. The translation policy management module can be configured to manage the jargon translation policy associated with each of the first and second user communication modules. The jargon translation module can be configured to analyze the jargon translation policy associated with the first and second user communication modules to determine whether jargon translation is enabled for the message. The jargon translation module can be configured to translate the jargon incorporated into the message when it is determined that jargon translation is enabled. The translation policy management module can be configured to manage jargon translation preferences of users.

According to the first aspect, the communication enabler server module can include a storage module. The storage module can be configured to store jargon translation information. The communication enabler server module can include a communication module. The communication module can be configured to communicate information with users. The system can include a system administration module in communication with the communication enabler server module. The system administration module can be configured to administer the communication enabler server module. According to an exemplary embodiment of the first aspect, the first user communication module can be configured to communicate a message without jargon to the second user communication module. Accordingly, the jargon translation module can be configured to translate information in the message into jargon in accordance with the jargon translation policy associated with at least one of the first and second user communication modules. The message can comprise, for example, an instant messaging (IM) message or the like. Alternatively, the message can comprise a short message service (SMS) message or the like. The jargon translation module can be configured to translate substantially the entire message in accordance with jargon translation policy associated with at least one of the first and second user communication modules. Additionally, the jargon translation module can be configured to translate the message in accordance with a destination of the message.

According to a second aspect of the present invention, an apparatus for managing jargon in messages includes a user communication device. The user communication device is adapted to communicate a message incorporating jargon to a second user communication device. The user communication device includes communication enabler structure. The communication enabler structure includes jargon translation structure. The jargon translation structure is adapted to translate the jargon incorporated into the message in accordance with jargon translation policy associated with at least one of the user communication device and the second user communication device. The communication enabler structure is adapted to communicate a jargon translated message to the second user communication device in accordance with the jargon translation policy.

According to the second aspect, the communication enabler structure can include translation policy management structure. The translation policy management structure can be adapted to manage the jargon translation policy associated with each of the first and second user communication devices. The jargon translation structure can be adapted to analyze the jargon translation policy associated with the first and second user communication devices to determine whether jargon translation is enabled for the message. The jargon translation structure can be adapted to translate the jargon incorporated into the message when it is determined that jargon translation is enabled. The translation policy management structure can be adapted to manage jargon translation preferences of users.

According to the second aspect, the communication enabler structure can include communication structure. The communication structure can be adapted to communicate information with users. The communication enabler structure can include storage structure. The storage structure can be adapted to store jargon translation information. A system administration server can be in communication with the communication enabler structure. The system administration server can be adapted to administer the communication enabler structure. According to an exemplary embodiment of the second aspect, the first user communication device can be adapted to communicate a message without jargon to the second user communication device. Accordingly, the jargon translation structure can be adapted to translate information in the message into jargon in accordance with the jargon translation policy associated with at least one of the first and second user communication devices. The message can comprise, for example, an IM message or the like. Alternatively, the message can comprise a SMS message or the like. The jargon translation structure can be adapted to translate substantially the entire message in accordance with jargon translation policy associated with at least one of the user communication devices. Additionally, the jargon translation structure can be adapted to translate the message in accordance with a destination of the message.

According to a third aspect of the present invention, a method of communicating information content incorporating jargon includes the steps of: communicating information content incorporating jargon from a first user communication device to a second user communication device; translating the jargon incorporated into the information content in accordance with jargon translation policy associated with at least one of the first and second user communication devices; and communicating jargon translated information content to the second user communication device in accordance with the jargon translation policy.

According to the third aspect, the method can include one or more of the following steps: generating the information content incorporating jargon; accessing the jargon translation policy associated with the first and second user communication devices; analyzing the jargon translation policy associated with the first and second user communication devices to determine whether jargon translation is enabled for the information content; and translating the jargon incorporated into the information content when it is determined that jargon translation is enabled in accordance with the jargon translation policy. According to an alternative exemplary embodiment, the method can include the steps of: communicating information content without jargon from the first user communication device to the second user communication device; and translating information in the information content into jargon in accordance with the jargon translation policy associated with at least one of the first and second user communication devices.

According to the third aspect, the method can include one or more of the following steps: managing the jargon translation policy associated with each of the first and second user communication devices; managing jargon translation preferences of users; and storing jargon translation information. The information content can comprise, for example, an IM message or the like. Alternatively, the information content can comprise, for example, a SMS message or the like. The method can also include the step of translating substantially the entire information content in accordance with jargon translation policy associated with at least one of the first and second user communication devices. Additionally, the method can include the step of translating the information content in accordance with a destination of the information content.

According to a fourth aspect of the present invention, a system for communicating messages incorporating jargon includes means for enabling messaging. The messaging enabling means is in communication with a plurality of user communication units. A first user communication unit is configured to communicate a message incorporating jargon to a second user communication unit. The messaging enabling means includes means for translating jargon. The jargon translating means is configured to translate the jargon incorporated into the message in accordance with jargon translation policy associated with at least one of the first and second user communication units. The messaging enabling means is configured to communicate a jargon translated message to the second user communication unit in accordance with the jargon translation policy.

According to the fourth aspect, the messaging enabling means can include means for managing translation policy. The translation policy managing means can be configured to manage the jargon translation policy associated with each of the first and second user communication units. The jargon translating means can be configured to analyze the jargon translation policy associated with the first and second user communication units to determine whether jargon translation is enabled for the message. The jargon translating means can be configured to translate the jargon incorporated into the message when it is determined that jargon translation is enabled. The translation policy managing means can be configured to manage jargon translation preferences of users.

According to the fourth aspect, the messaging enabling means can include means for storing information. The information storing means is configured to store jargon translation information. The messaging enabling means can include means for communicating information. The information communicating means can be configured to communicate information with users. The system can include means for administering the system in communication with the messaging enabling means. The system administering means can be configured to administer the messaging enabling means. The first user communication unit can be configured to communicate a message without jargon to the second user communication unit. The jargon translating means can be configured to translate information in the message into jargon in accordance with the jargon translation policy associated with at least one of the first and second user communication units. The message can comprise, for example, an IM message or the like. Alternatively, the message can comprise, for example, a SMS message or the like. The jargon translating means can be configured to translate substantially the entire message in accordance with jargon translation policy associated with at least one of the first and second user communication units. Additionally, the jargon translating means can be configured to translate the message in accordance with a destination of the message.

According to a fifth aspect of the present invention, an apparatus for managing jargon in communications includes a user communication device. The user communication device is adapted to communicate information content incorporating jargon to a second user communication device. The user communication device includes means for enabling jargon communication. The jargon communication enabling means includes means for translating jargon. The jargon translating means is adapted to translate the jargon incorporated into the information content in accordance with jargon translation policy associated with at least one of the user communication device and the second user communication device. The jargon communication enabling means is adapted to communicate jargon translated information content to the second user communication device in accordance with the jargon translation policy.

According to the fifth aspect, the jargon communication enabling means can include means for managing translation policy. The translation policy managing means can be adapted to manage the jargon translation policy associated with each of the first and second user communication devices. The jargon translating means can be adapted to analyze the jargon translation policy associated with the first and second user communication devices to determine whether jargon translation is enabled for the information content. The jargon translating means can be adapted to translate the jargon incorporated into the information content when it is determined that jargon translation is enabled. The translation policy management structure can be adapted to manage jargon translation preferences of users.

According to the fifth aspect, the jargon communication enabling means can include means for communicating. The communicating means can be adapted to communicate information content with users. The jargon communication enabling means can include means for storing. The storing means can be adapted to store jargon translation information. A means for administering the apparatus can be in communication with the jargon communication enabling means. The apparatus administering means can be adapted to administer the jargon communication enabling means. According to an alternative exemplary embodiment of the fifth aspect, the first user communication device can be adapted to communicate information content without jargon to the second user communication device. The jargon translating means can be adapted to translate information in the information content into jargon in accordance with the jargon translation policy associated with at least one of the first and second user communication devices. The information content can comprise, for example, an IM message or the like. Alternatively, the information content can comprise, for example, a SMS message or the like. The jargon translating means can be adapted to translate substantially the entire information content in accordance with jargon translation policy associated with at least one of the user communication devices. Additionally, the jargon translating means can be adapted to translate the information content in accordance with a destination of the information content.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for communicating messages incorporating jargon, in accordance with an exemplary embodiment of the present invention.

FIG. 2 is a flowchart illustrating steps for translating jargon, in accordance with an exemplary embodiment of the present invention.

FIG. 3 is a block diagram illustrating a system for managing jargon in messages, in accordance with an alternative exemplary embodiment of the present invention.

FIG. 4 is a flowchart illustrating steps for communicating messages incorporating jargon, in accordance with an exemplary embodiment of the present invention.

### DETAILED DESCRIPTION OF THE PREFERRED EMBODIMENTS

Exemplary embodiments of the present invention are directed to a system and method for handling jargon in communication systems. The present invention can allow users and communication systems to manage jargon, providing end users with the ability to translate incoming messages containing unknown words, expressions, symbols, shortcuts, paragraphs, idioms, concepts, and the like. For example, the present invention can be used in messaging systems to allow unaware or unfamiliar users to be able to easily comprehend messages that include such jargon and shortcuts. Alternatively, users with small screens (e.g., on mobile or handheld communication devices) or for other reasons can receive and/or display jargon or shortcuts automatically, where appropriate, instead of long phrases. Exemplary embodiments of the present invention can perform such jargon translation on the server side, on the client/recipient side, or in a mixed server/client mode. Any suitable type of messaging or communication system (e.g., e-mail, instant messaging (IM), short message service (SMS), enhanced messaging service (EMS), multimedia messaging service (MMS), or the like) can utilize the jargon handling system of the present invention.

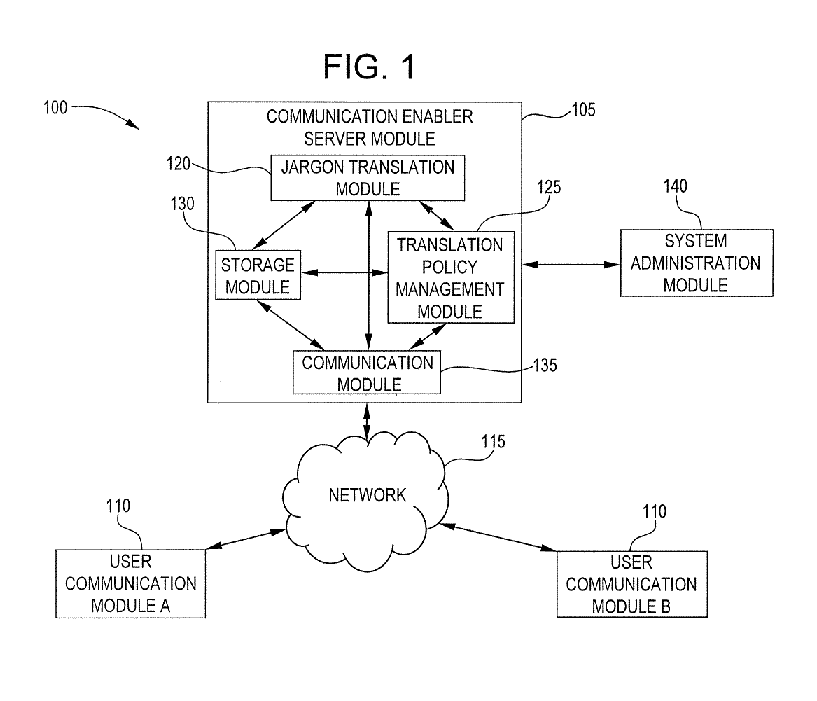

These and other aspects and embodiments of the present invention will now be described in greater detail. FIG. 1 is a block diagram illustrating a system 100 for communicating messages incorporating jargon, in accordance with an exemplary embodiment of the present invention. The system 100 can support any suitable type of communicable information content that can include or otherwise incorporate jargon. According to exemplary embodiments, the jargon can comprise any suitable type of shorthand, abbreviation, acronym, shortcut, symbol, icon, unknown/unusual word(s), expression, paragraph, idiom, concept, idea, impression, slang, specialized or technical language of a trade, profession, or similar group, simple language translations, spelling corrections, corporate/enterprise terminology, or other appropriate type of jargon that is capable of expressing thoughts, ideas, concepts, impressions, and other like information that is frequently discussed between members of a group. For example, the jargon can comprise internet jargon (e.g., “BRB”/“Be Right Back”), professional terminology (e.g., medical disease, such as “myocardial infarction”/“heart attack”), messenger symbols or icons (e.g., emoticons, such as “:-)”/“<<smile>>”), political correctness (e.g., “d#$n”/“darn”), language translations (e.g., “gracias”/“thank you”), spelling corrections (“plaese”/“please”), corporate/enterprise vocabulary (e.g., terms specific to the products, services, processes, departments, or the like of an organization), and the like.

The system 100 includes a communication enabler server module 105. The communication enabler server module 105 is in communication with a plurality of user communication modules 110. For example, the communication enabler server module 105 can comprise or form a part or portion of any suitable type of messaging enabler, such as, for example, a presence server, an IM Service Center (e.g., an IM enabler), a Short Message Service Center (SMSC), or the like, although the communication enabler server module 105 can comprise any suitable type of communication device, component, or module that is capable of enabling communication of information between users. For purposes of illustration and not limitation, the communication enabler server module 105 can be in communication with a first user communication module A and a second user communication module B. However, any suitable number of user communication modules 110 (e.g., user communication module 1, user communication module 2, user communication module 3, . . . , user communication module N, where N is any appropriate number) can be used with the system 100 in accordance with exemplary embodiments of the present invention. Each user communication module 110 can comprise any suitable type of wireless or wired communication module or device that is capable of receiving and transmitting messages and other information using any appropriate type of communication service. For example, each of the user communication modules 110 can comprise a mobile or handheld device (e.g., cellular telephone, personal digital assistant (PDA)), a personal computer (PC), or other like communication endpoint.

The communication enabler server module 105 can be in communication with the user communication modules 110 via network 115. The network 115 can comprise any suitable type of wireless and/or wired communication network. The network 115 can be operated or otherwise managed by any appropriate type of network operator, including, but not limited to, a Mobile Network Operator (MNO), a mobile virtual network operator, a wireless service provider, a wireless carrier, a mobile phone operator, a cellular company or organization, a fixed network operator, a converged network operator, or any suitable combination thereof. Although one network 115 is illustrated in FIG. 1, skilled artisans will recognize that any suitable number (e.g., network 1, network 2, network 3, . . . , network M, where M is any appropriate number) and kinds (e.g., wired, wireless, or combination thereof) of networks 115 can be used with system 100 in accordance with exemplary embodiments. The network 115 can support or otherwise provide any suitable type of messaging or communication service or system (e.g., e-mail, IM, SMS, EMS, MMS, or the like), and all such services and systems can be configured to utilize the jargon handling system 100 of the present invention. Each user communication module 110 can belong to the same or different network 115 as any other user communication module 110. For example, user communication module A can belong to or otherwise be associated with the same or different network 115 and network operator as user communication module B. According to an exemplary embodiment, the first user communication module A can be configured to communicate a message or other information content incorporating jargon to the second user communication module B.

The communication enabler server module 105 includes a jargon translation module 120. The jargon translation module 120 is configured to translate or otherwise convert the jargon incorporated into the message or other communicated information in accordance with jargon translation policy associated with either or both of the first and second user communication modules 110. The communication enabler server module 105 is configured to communicate a jargon-translated message to the second user communication module in accordance with the jargon translation policy. According to an exemplary embodiment, the communication enabler server module 105 can be used in, for example, the messaging context to translate jargon into the corresponding full or complete text or phrase to allow unaware or unfamiliar users to be able to easily comprehend such messages. However, the communication enabler server module 105 can support any suitable type and form of communicable information content that can include or otherwise incorporate jargon. According to an alternative exemplary embodiment, users with small screens (e.g., on mobile or handheld communication devices) or for other reasons can have the jargon translation module 120 translate long text and phrases into jargon, where appropriate, so that the corresponding jargon can be received and/or displayed instead of such long phrases. The jargon translation module 120 is configured to choose the appropriate textual or other format that meets the demands of the users, as specified by corresponding jargon translation policy. The communication enabler server module 105 and the jargon translation module 120 can be used with and for any suitable type of media that includes text or other appropriate rich (e.g., non-text) content that is capable of being translated to/from jargon, including, but not limited to, SMS messages, IM messages, e-mail, MMS messages, Microsoft Word documents, spreadsheets, Adobe Acrobat PDF documents, visual or graphical media, aural content, multimedia information, and the like.

For purposes of illustration and not limitation, the jargon translation module 120 can be configured to operate in accordance with a suitable Text-to-Speech (TTS) system, such as an e-mail reader or the like. For example, a user communication module 110 can be used to compose a text communication that includes jargon. The jargon translation module 120 can be configured to expand the jargon (or contract long phrases into jargon) in the text, and pass this information to the TTS system so that the jargon translated message can be spoken or otherwise verbally communicated to the recipient (e.g., visually-impaired users). Additionally, the jargon translation module 120 can be configured to operate in accordance with a suitable speech recognition system. For example, a user communication module 110 can be used to compose a voice message that includes jargon. The speech recognition system can be used to convert the speech into text, and the jargon translation module 120 can be configured to expand the jargon (or contract long phrases into jargon) in the text. The jargon translated message can then be forwarded to the recipient (e.g., visually-impaired users). For example, the jargon translated message can be passed to a TTS system to have such message verbally communicated to the recipient.

In addition, the jargon translation module 120 can be configured to operate in accordance with suitable visual recognition systems. For example, a user communication module 110 can be used to compose a text or voice communication that incorporates jargon. The jargon translation module 120 can be used to expand the jargon (or contract long phrases into jargon) in the text or voice (e.g., in conjunction with a speech recognition system, as discussed previously). The jargon translated communication can then be passed to the visual recognition system to convert such message into a picture or other visual representation of the jargon translated message (e.g., for hearing-impaired users). Additionally, the jargon translation module 120 can be configured to operate in accordance with suitable dictation systems. For example, a user communication module 110 can be used to compose a voice message comprised of pronounced letters (e.g., “Alpha” for the letter “A,” “Bravo” for the letter “B,” “Charlie” for the letter “C,” and the like) to spell out words or phrases. Alternatively, low bandwidth or real-time systems in which there is a limited ability to pronounce long phrases may use short-coded words (e.g., for military communications or for communications in noisy environments). In either embodiment, the jargon translation module 120 can be used to expand the words from the spellings or other short-coded words (e.g., in conjunction with a speech recognition system, as discussed previously). The jargon translated message can then be forwarded to the recipient. For example, the jargon translated message can be passed to a TTS system to have such message verbally communicated to the recipient.

Each or any user of the system 100 can specify their translation preferences for messages or other like information that are communicated to and from that user. Such preferences can be captured and maintained for each user in a corresponding jargon translation policy. The jargon translation policy of each user can specify any suitable type of preferences or settings for performing jargon translation, such as, for example, when such jargon translation is to be performed (e.g., for every message received, for only messages received from a certain user or users, when any message is sent), the type of jargon translation that is to occur (e.g., translate jargon into corresponding phrases when message is received, translate phrases into jargon when sending message), rules for jargon translation (e.g., translate “BRB” into “Be Right Back”), and other like policies and preferences. Such jargon translation policies can be used by the jargon translation module 120 to determine when and how jargon and phrases in messages and other like information are to be translated. Each user can create personal jargon translation policies for both incoming and outgoing messages and communications, e.g., based upon the type of communication that is being created or received. For example, e-mail messages can use different jargon translation policies than IM messages. Additionally, users can chose to use certain jargon translation policies for particular communications. For example, a user can specify to use a certain type of jargon translation policy for a given message or when communicating with a particular user (e.g., using abbreviation jargon translation policy, but not medical jargon translation policy).

For purposes of illustration and not limitation, a doctor could specify a jargon translation policy that any messages that contain medical terminology that are addressed to patients should have the medical terminology translated to plain language (e.g., replacing “myocardial infarction” with “heart attack”). Additionally, a user could specify a jargon translation policy that a “wink” (e.g., an emoticon represented as “;-)”) in a communication be replaced with either a textual equivalent (e.g., “<<wink>>”) or a graphical and/or vocal inference. Another user could specify a jargon translation policy that any audio and/or video clips in a received message should be replaced with, for example, the (textual) subject of the audio/video clip instead of the showing the clip itself (e.g., due to limitations in the capabilities of the recipient's communication device). A user can also specify a jargon translation policy that the entire or substantially entire text of a communication is to be translated (e.g., from one language to another). An organization (e.g., a company or other enterprise) can specify a jargon translation policy that information sent internally within the organization to employees is to include shortcuts to business-related information, but any such information sent externally to third parties is to have the business-related information fully included or otherwise expanded in those communications.

Thus, exemplary embodiments of the present invention can perform jargon translation based on the destination or domain of the destination of the message or other communicated information. Such per domain or per destination jargon translation policies can support different translations depending on the entity, organization, enterprise, company, region, domain, or the like for which the message or communication is destined. Furthermore, for broadcast or one-to-many communications (e.g., in a chat room or the like), the outgoing information can be jargon translated for some recipients and not translated for others, depending on the jargon translation policy associated with each recipient, so that each recipient can receive a message with a different level of jargon translation. Accordingly, the same communication can be jargon translated differently (or not at all) so that the resulting received communication is tailored according to the jargon translation preferences of each recipient (and/or the (lone) sender).

Additionally, an operator can create operator-specified jargon translation policies for both incoming and outgoing communications, for example, based on the type of message that is being transmitted or received (e.g., IM messages can use different jargon translation policies than SMS messages). General purpose or system-wide jargon translation policies can also be created for either or both of incoming and outgoing communications (e.g., based on the type of message that is being created or received). For example, a general purpose jargon translation policy can specify that the original text of a message is to be transmitted and available at the destination along with the jargon translated message. Alternatively, the general purpose jargon translation policy can specify that any changes made to a communication can be indicated in the communication as to where such changes were made (e.g., change tracking that specifies strikethroughs of deleted text and underlining of added text). Thus, the jargon translation module 120 can be configured to analyze or otherwise examine the jargon translation policy associated with the user communication modules 110 or any other user, operator, or other entity associated with the system 100 to determine whether jargon translation is enabled when communicating a message or other information, how such jargon translation is to be performed, and to what extent.

For example, the user of user communication module A (i.e., user A) may desire to send a message incorporating jargon to the user of user communication module B (i.e., user B). The jargon translation module 120 can examine the jargon translation policy associated with each of user communication modules A and B to determine whether jargon translation is to be performed. For example, the jargon translation policy associated with user communication module A can specify that jargon translation is not be performed when communications are sent. However, the jargon translation policy associated with user communication module B can specify that jargon translation is to be performed on all received communications. Thus, the jargon translation module 120 can be configured to translate the jargon incorporated into the message when it is determined that jargon translation is enabled.

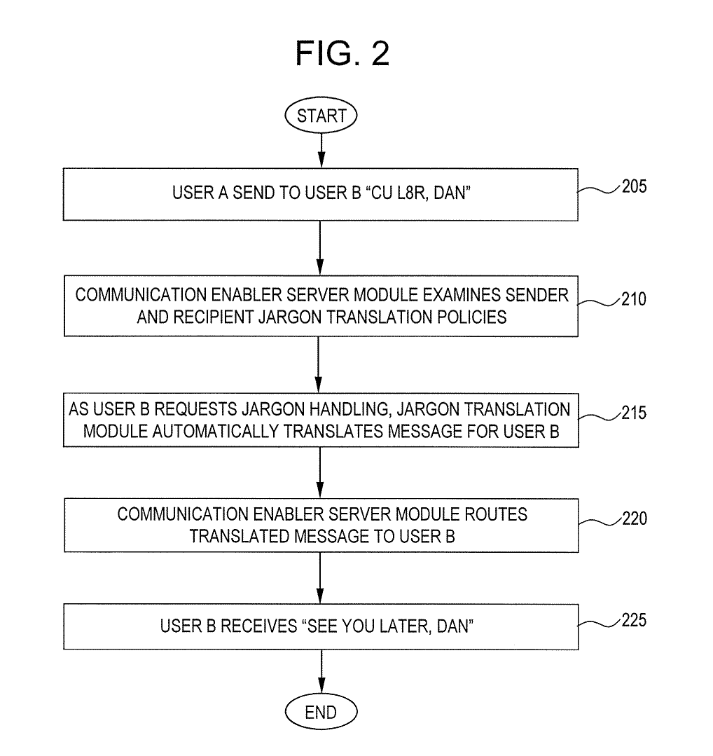

Such an illustrative scenario is depicted in FIG. 2. In particular, FIG. 2 is a flowchart illustrating steps for translating jargon, in accordance with an exemplary embodiment of the present invention. In step 205, user A sends to user B a message stating “cu l8r, dan,” which is shorthand for “See you later, Dan.”. In step 210, the communication enabler server module 105 (via the jargon translation module 120) examiners the sender and recipient jargon translation policies (managed by the translation policy management module 125). For purposes of the present illustration, the jargon translation policy of user B indicates that user B is jargon unaware, and, therefore, requires jargon translation on incoming messages. Consequently, in step 215, as user B requests jargon handling, the jargon translation module 120 can automatically translate the message for the convenience of user B. In step 220, the communication enabler server module 105 can route the translated message to user B (via the communication module 135). In step 225, user B receives the jargon-translated message of “See you later, dan”. In other words, since the jargon translation policy associated with user communication module B specifies such translation, the jargon translation module 120 can perform the jargon translation before the message is forwarded to user communication module B. However, either user can also choose (for either or both incoming or outgoing messages) whether or not to use personal, operator, and/or general purpose jargon translation policies on a specific message, a session, always, or over any other interval. For example, user B can specify that operator and general purpose jargon translation policies are not to be used on the aforementioned message received from user A.

To manage the jargon translation policy associated with user communication modules 110, the communication enabler server module 105 can include a translation policy management module 125. The translation policy management module 125 can be in communication with the jargon translation module 120. The translation policy management module 125 can be configured to manage the jargon translation policy and preferences associated with each of the user communication modules 110 (e.g., user communication modules A and B). For example, the translation policy management module 125 can be configured to manage the jargon translation preferences of users. A separate jargon translation policy record can be maintained for each user and user communication module 110 by the translation policy management module 125, either as separate files or as part of a single, comprehensive jargon translation policy applicable to al users. The jargon translation policy associated with each user communication module 110 can be created, modified, and updated by the corresponding user at any appropriate time by suitably interacting with the translation policy management module 125 (e.g., via an appropriate graphical and/or textual interface, by sending commands or requests to the communication enabler server module 105, specifying preferences in a policy document that is forwarded to the communication enabler server module 105, or other like interactive mechanisms). The translation policy management module 125 can maintain and manage any suitable type of preferences, account settings, or other profile information associated with each user communication module 110.

The translation policy management module 125 can also be used to manage jargon translation policy and preferences from other entities that use or are otherwise associated with the system 100, such as one or more communication service operators. Such operators can establish appropriate preferences or policies that are applicable to individual users or groups of users, all of which can be managed and maintained according to exemplary embodiments. For example, a particular operator (e.g., the communication service operator providing communication services to user communication module A) can establish a preference or policy that any messages incorporating offensive jargon (e.g., scatological jargon) that are transmitted from users in the operator's network to users in a particular remote operator network are to be translated so as to remove any such offensive jargon.

According to exemplary embodiments, the jargon translation module 120 can be configured to translate the jargon incorporated into a communication or translate phrases in a communication into jargon in any suitable manner. According to one exemplary embodiment, the jargon translation module 120 can include appropriate look-up tables that can used to perform the jargon translation for each user. Such look-up tables can be stored in a suitable computer memory or other computer storage device internal to or in communication with the jargon translation module 120 and/or the communication enabler server module 105. For purposes of illustration and not limitation, Table 2 illustrates an exemplary look-up table that can be used to perform jargon translation for each user.

TABLE 2
Exemplary look-up table for performing jargon translation.

| JARGON | PHRASE |
|---|---|
| BRB | Be Right Back |
| BTW | By The Way |
| CU | See You |
| HHOK | Ha Ha Only Kidding |
| IMHO | In My Humble Opinion |
| L8R | Later |
| TTFN | Ta-Ta For Now |
| TTYL | Talk To You Later |
| myocardial infarction | heart attack |
| :-) | <<smile>> |
| :-( | <<frown>> |

In Table 2, for each piece of jargon in a message or the like, the jargon translation module 120 can look-up the corresponding phrase or description of that piece of jargon. For example, if a message contains the jargon “IMHO,” the jargon translation module 120 can use the look-up table to replace that jargon with its corresponding full phrase of “In My Humble Opinion.” If a communication contains technical or professional terminology, such as “myocardial infarction,” the jargon translation module 120 can use the look-up table to replace that term with its plain language variant, such as “heart attack.” Additionally, if a message or other like communication contains an emoticon of “:-)”, the jargon translation module 120 can use the look-up table to replace the symbol with the corresponding description of “<<smile>>”.

The jargon translation module 120 can also be configured to translate non-jargon information or phrases in a communication into jargon in accordance with the jargon translation policy associated with the user communication modules 110 of the sender and recipient of the message. To perform such reverse translation (i.e., translating words or phrases into jargon), the jargon translation module 120 can perform a reverse look-up for that word or phrase to get the corresponding jargon. For example, if a communication contains the phrase “By The Way,” the jargon translation module 120 can use the look-up table to replace the phrase with the corresponding jargon of “BTW.” The j argon translation module 120 can use suitable pattern-, text-, and/or voice-recognition algorithms or other like mechanisms known to those of ordinary skill in the art to search for and replace or otherwise modify the jargon or phrases within a communication.

Using a look-up table such as that illustrated in Table 2, the jargon translation module 120 can maintain any and all suitable jargon translations associated with each user communication module 110. For example, separate look-up tables can be maintained for each user communication module 110, a single look-up table can be maintained for all users that incorporates the particular jargon translations specified by each user, or a combination of both scenarios (e.g., a generic look-up table for all users, and individual look-up tables for each, any, or all users). According to an exemplary embodiment, general purposes look-up tables can be provided for use by all users, including, but not limited to, look-up tables for medical terminology, common abbreviations, simple language translations (e.g., “gracias”/“thank you”), emoticons, spelling corrections (e.g., “plaese”/“please”), and the like. Any and all such look-up tables can be configured to maintain any suitable type and number of jargon translations depending on, for example, the number of users of the system 100. Additionally, as skilled artisans will recognize, the nature and content of the jargon translations contained in such a look-up table(s) will depend on, for example, the type and nature of communication services and platforms supported, operator policies and preferences, user policies and preferences, jargon used by users, and other like factors. As discussed previously, whether or not such translations are performed for each user will depend on the jargon translation policy established for each user and associated with each corresponding user communication module 110.

According to an exemplary embodiment, where a message is changed from one type to another (e.g., from SMS to IM, or from IM to SMS), then the look-up tables can be configured to support different translations depending on the type of message. For example, Table 3 illustrates an exemplary look-up table that can be used to perform jargon translation for different message types.

TABLE 3
Exemplary look-up table for performing jargon
translation for different message types.

| | | ORIGI- | | | |
|---|---|---|---|---|---|
| | PHRASE | NATION | IM | SMS | E-MAIL |
| (1) | In my humble | E-mail | IMHO | IMHO | In my humble |
| | opinion | | | | opinion |
| (2) | IMHO | IM | IMHO | IMHO | In my humble |
| | | | | | opinion |
| (3) | IMHO | SMS | IMHO | IMHO | In my humble |
| | | | | | opinion |

As illustrated in the row (1) of Table 3, when an originating e-mail message contains the phrase “in my humble opinion,” and that message is destined for a SMS system, then the phrase is to be translated into the corresponding jargon (i.e., “IMHO”). However, as illustrated in row (3), when an originating SMS message contains the phrase “IMHO,” and that message is destined for an IM system, then the phrase is to be left in its jargon form (i.e., “IMHO”). The look-up tables illustrated above and discussed herein can be configured according to the needs and preferences of the users, operators, and other entities that interact with the system 100. For example, Table 4 illustrates an alternative exemplary look-up table to Table 3 that can be used to perform jargon translation for different message types.

TABLE 4
Alternative exemplary look-up table for performing
jargon translation for different message types.

| | | | DESTINATION | | |
|---|---|---|---|---|---|
| | PHRASE | ORIGINATION | IM | SMS | E-MAIL |
| (1) | <<smile>> | E-mail | [symbol] | :-) | <<smile>> |
| (2) | [symbol] | IM | [symbol] | :-) | <<smile>> |
| (3) | :-) | SMS | [symbol] | :-) | <<smile>> |

As illustrated in row (2) of Table 4, when an originating IM message contains an emoticon of “ [symbol] ,” and that message is destined for a SMS system, then the emoticon is to be translated to a textual emoticon supported by the SMS system (i.e., “:-)”). However, if the message is destined for an e-mail system, then the emoticon is to be translated to a textual representation of the emoticon (i.e., “<<smile>>”). Any and all such translations can be supported through the use of such look-up tables by the jargon translation module 120.

Alternatively, suitable Boolean or other logic or rules can be used for translating phrases into jargon and/or jargon into phrases for each user. For example, continuing with the present illustration (and assuming that the jargon translation policy of a user specifies that jargon translation is to be performed for all received communications), Boolean logic can be used to determine that IF a communication contains the jargon “IMHO,” THEN replace with “In My Humble Opinion.” Likewise, Boolean logic can be used to determine that IF a communication contains the phrase “myocardial infarction,” THEN replace with “heart attack.” Finally, Boolean logic can be used to determine that IF a communication contains the jargon “:-)”, THEN replace with “<<smile>>”. The complexity of such logic or rules will depend on the nature and type of the jargon translations and jargon translation policy maintained and supported by the various communication systems and the system 100, as well as other like factors. More complex mechanisms, such as neural networks, can be adapted to “learn” how to respond to translate such jargon. For example, according to an exemplary embodiment, the jargon translation module 120 can “learn” that the jargon “IMHO” translates to “In My Humble Opinion,” while “:-)” translates to “<<smile>>”. Such information can be fed back to the jargon translation module 120 to allow such “learning” to take place and to refine these or other like translation algorithms.

The communication enabler server module 105 can include a storage module 130 that can be in communication with either or both of the jargon translation module 120 and the translation policy management module 125. The storage module 130 can be configured to store jargon translation information. For example, the storage module 130 can store the jargon translation policies, preferences, and other setting and profiles specified by the users. The translation policy management module 125 can store jargon translation policies in the storage module 130, and the jargon translation module 120 can access or otherwise retrieve such policies and other preference information when performing jargon translation. However, the storage module 130 can be used to store any suitable type of information used or maintained by the communication enabler server module 105 and the system 100. The storage module 130 can be comprised of any suitable type of computer-readable or other computer storage medium capable of storing information in electrical or electronic form.

The communication enabler server module 105 can include a communication module 135. The communication module 135 is configured to communicate communication information with the users (e.g., messages or other communications (translated or not), jargon translation policy or other preference information, and the like). However, each of the modules of the communication enabler server module 105 can use the communication module 135 to communicate any suitable type of information to, for example, users, operators, and other entities using or otherwise in communication with the system 100. The communication module 130 can be adapted to use any suitable type of wireless or wired communication link, connection, or medium that uses an appropriate form of wireless or wired communication mechanism, protocol, or technique, or any suitable combination thereof, to communicate with the various entities of the system 100. In other words, the communication module 135 can be configured to use any or all of a plurality of communication access protocols to support various suitable types of networks, security settings, communication environments, and the like.

The system 100 can include a system administration module 140 in communication with the communication enabler server module 105 (e.g., via the communication module 135). The system administration module 235 can be configured to administer or otherwise manage the communication enabler server module 105 (or any of the modules thereof) and the jargon translation information of the users. The system administration module 140 can be used by, for example, a service provider, a system administrator, operator, or the like to manage and maintain any or all aspects of the communication enabler server module 105.

The system 100 can include suitable additional modules or components as necessary to assist or augment the functionality of any or all of the modules of the system 100. For example, each communication service operator or provider can include one or more suitable communication servers. Each communication server can be in communication with the communication enabler server module 105, with the respective user communication modules 110 (within the operator network), and with each other (and other like modules) to facilitate communication transactions throughout the system 100. For example, user communication module A can be in communication with a communication server A that is in communication with the communication enabler server module 105 (via network 115). User communication module B can be in communication with a communication server B that is in communication with the communication enabler server module 105 (via network 115). Communication servers A and B can also be in communication with each other (via network 115) to facilitate communication between user communication modules A and B. Such communication servers can forward the messages to the communication enabler server module 105 (via network 115) for appropriate translation. The number and type of such communication servers will depend on the number and type of communication services offered in each operator network. For example, each communication server can comprise a suitable type of service enabler, such as, for example, an IM Service Center (e.g., an IM enabler), a Short Message Service Center (SMSC), e-mail server, MMS Center (MMSC), a gaming or other application server, or the like.

Additionally or alternatively, the system 100 can include additional database or storage modules that can be internal to or communication with the communication enabler server module 105. Such storage modules can be configured to store any suitable type of information generated or used by or with the system 100. The storage modules can be comprised of any suitable type of computer-readable or other computer storage medium capable of storing information in electrical or electronic form.

Those of ordinary skill in the art will recognize that each of the modules of the system 100 can be located locally to or remotely from each other, while use of the system 100 as a whole still occurs within a given country, such as the United States. For example, merely for purposes of illustration and not limitation, the communication enabler server module 105 (including the jargon translation module 120, the translation policy management module 125, the storage module 130, and the communication module 135) can be located extraterritorially to the United States (e.g., in Canada and/or in one or more other foreign countries). However, the user communication devices 110 can be located within the United States, such that the control of the system 100 as a whole is exercised and beneficial use of the system 100 is obtained by the user within the United States.

Each of modules of the system 100, including the communication enabler server module 105 (including the jargon translation module 120, the translation policy management module 125, the storage module 130, and the communication module 135), and the user communication modules 110, or any combination thereof, can be comprised of any suitable type of electrical or electronic component or device that is capable of performing the functions associated with the respective element. According to such an exemplary embodiment, each component or device can be in communication with another component or device using any appropriate type of electrical connection or communication link (e.g., wireless, wired, or a combination of both) that is capable of carrying such information. Alternatively, each of the modules of the system 100 can be comprised of any combination of hardware, firmware and software that is capable of performing the functions associated with the respective module.

Alternatively, each, any, or all of the components of the system 100 (including the communication enabler server module 105 and the user communication modules 110) can be comprised of one or more microprocessors and associated memory(ies) that store the steps of a computer program to perform the functions of one or more of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of one or more of the modules of the system 100. For example, the actual source code or object code of the computer program can be stored in the memory.

Alternative architectures or structures can be used to implement the various functions of the system 100 as described herein. For example, functions from two or more modules can be implemented in a single module, or functions from one module can be distributed among several different modules. For example, the translation policy management module 125 can form a component of the jargon translation module 120, such that the jargon translation module 120 is configured to perform the functionality of that (incorporated) module.

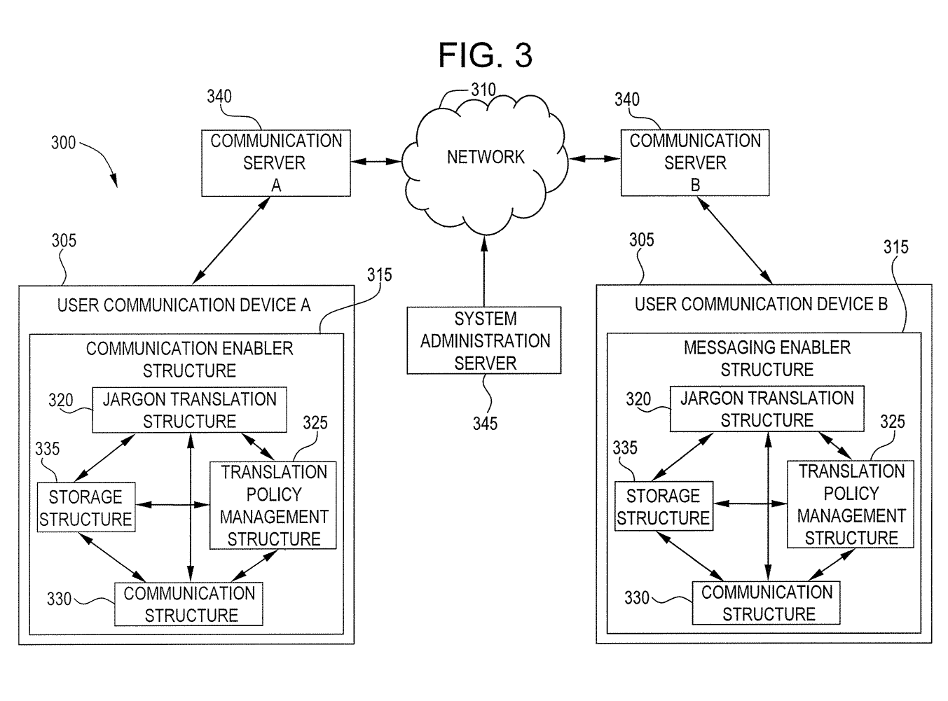

The exemplary embodiment illustrated in FIG. 1 can provide centralized, server-side jargon translation. Alternatively, the jargon translation described herein can be performed on the client-side so as to distribute such functionality throughout the system. For purposes of illustration and not limitation, FIG. 3 is a block diagram illustrating a system 300 for managing jargon in messages, in accordance with an alternative exemplary embodiment of the present invention. The distributed system 300 includes one or more user communication devices 305 (e.g., user communication device A and user communication device B, although the system 300 can support any suitable number of such user communication devices 305). For example, first user communication device A can be adapted to communicate a message incorporating jargon to a second user communication device B via the network 310. Each user communication device 305 includes communication enabler structure 315. The communication enabler structure 315 includes jargon translation structure 320. The jargon translation structure 320 is adapted to translate the jargon incorporated into the message in accordance with jargon translation policy associated with either or both of the first and second user communication devices 305 (e.g., in a manner similar to that described previously for the jargon translation module 120). The communication enabler structure 315 is adapted to communicate a jargon translated message from the first user communication device 305 (e.g., user communication device A) to the second user communication device 305 (e.g., user communication device B) in accordance with the jargon translation policy.

The communication enabler structure 315 can include translation policy management structure 325. The translation policy management structure 325 can be in communication with the jargon translation structure 320. The translation policy management structure 325 can be adapted to manage the jargon translation policy associated with each of the first and second user communication devices 305 (e.g., in a manner similar to that described previously for the translation policy management module 125). In particular, the translation policy management structure 325 can be adapted to manage the jargon translation preferences of users. For example, the jargon translation structure 320 can be adapted to analyze the jargon translation policy associated with the first and second user communication devices 305 to determine whether jargon translation is enabled for the message. Accordingly, the jargon translation structure 320 can be adapted to translate the jargon incorporated into the message when it is determined that jargon translation is enabled. Alternatively, the first user communication device 305 (e.g., user communication device A) can be adapted to communicate a message without jargon to the second user communication device (e.g., user communication device B). The jargon translation structure 320 can be adapted to translate information in the message into jargon in accordance with the jargon translation policy associated with either or both of the first and second user communication devices 305.

The communication enabler structure 315 can include communication structure 330. The communication structure 330 can be adapted to communicate information with users (e.g., in a manner similar to that described previously for the communication module 135). Each of the modules of the communication enabler structure 315 can use the communication structure 330 to communicate any suitable type of information to, for example, users, operators, and other entities using or otherwise in communication with the system 300. The communication structure 330 can be adapted to use any suitable type of wireless or wired communication link, connection, or medium that uses an appropriate form of wireless or wired communication mechanism, protocol, or technique, or any suitable combination thereof, to communicate with the various entities of the system 300. In other words, the communication structure 330 can be configured to use any or all of a plurality of communication access protocols to support various suitable types of networks, security settings, communication environments, and the like.

The communication enabler structure 315 can include storage structure 335. The storage structure 335 can be adapted to store jargon translation information (e.g., in a manner similar to that described previously for the storage module 130). For example, the storage structure 335 can store the jargon translation policies, preferences, and other setting and profiles specified by the users. The translation policy management structure 325 can store jargon translation policies in the storage structure 335, and the jargon translation structure 320 can access or otherwise retrieve such policies and other preference information when performing jargon translation. However, the storage structure 335 can be used to store any suitable type of information used or maintained by the communication enabler structure 315. The storage structure 335 can be comprised of any suitable type of computer-readable or other computer storage medium capable of storing information in electrical or electronic form.

The system 300 can include suitable additional modules or components as necessary to assist or augment the functionality of the communication enabler structure 315 of each user communication device 305. For example, the system 300 can include one or more communication servers 340 in communication with each other (e.g., via network 310). Each communication server 340 can be in communication with one or more user communication devices 305. For example, communication server A can be in communication with user communication device A, and communication server B can be in communication with user communication device B. The communication servers 340 can be used for facilitating communication transactions between user communication devices 305.

The system 300 can also include a system administration server 345 in communication with the communication enabler structure 315 of each user communication device 305 (e.g., via network 310). The system administration server 345 can be adapted to administer the communication enabler structure 315 and the jargon translation information associated with each user communication device 305 (e.g., in a manner similar to that described previously for the system administration module 140). However, the system administration server 345 can be used to manage any and all appropriate aspects of the system 300.

Other alternative architectures or structures can be used to implement the various functions of the systems 100 and 300 as described herein. For example, the communication enabler structure 315 of the user communication devices 305 can instead reside in the respective communication servers 340. Alternatively, the jargon translation functionality can be distributed between a central server or component (e.g., the communication enabler server module 105 illustrated in FIG. 1) and the user communication devices (e.g., the user communication devices 305 illustrated in FIG. 3). To support such distributed architectures, the jargon translation policies of users can be maintained by the client (e.g., by the communication enabler structure 315), by the operator (e.g., by the communication enabler server module 105), by a shared resource, or a suitable combination thereof. Accordingly, the jargon translation can be performed on the client-side (e.g., by the jargon translation structure 320), on the server side (e.g., by the jargon translation module 120), or a suitable combination thereof (e.g., based on the type of information being communicated).

For purposes of illustration and not limitation, user A associated with user communication device A can create a communication for user B associated with user communication device B. Operator A manages the communication services for user communication device A (e.g., via communication server A), while operator B manages the communication services for user communication device B (e.g., via communication server B). Both user A and user B have specified jargon translation policies for such communications (e.g., to expand certain jargon, to contract particular phrases, or perform a suitable combination thereof for information content contained in such communications). User A can then send the communication to user B. The communication can be translated (e.g., by the jargon translation structure 320 of the communication enabler structure 315 of user communication device A) in accordance with i.) user A's “sending” jargon translation policies (e.g., special shorthand that user A prefers), ii.) operator A's “sending” jargon translation policies (e.g., special translations that operator A provides to users), and/or iii.) general purpose shared “sending” jargon translation policies (e.g., commonly accepted translations). The communication is then sent through operator A. The communication can be further translated (e.g., by the jargon translation module 120 of the communication enabler server module 105 that resides in, for example, communication server A) in accordance with i.) additional operator A “sending” jargon translation policies (e.g., operator A could require some translations not specified by user A), and/or ii.) additional general purpose “sending” jargon translation policies (e.g., operator A could require some general purpose translations for transmitted communications).

Continuing with the present illustration, the communication is received by operator B. The communication can be further translated (e.g., by the jargon translation module 120 of the communication enabler server module 105 that resides in, for example, communication server B) in accordance with i.) operator B's “receiving” jargon translation policies (e.g., operator B could require various translations for incoming communications), and/or ii.) general purpose “receiving” jargon translation policies (e.g., operator B could require several general purpose translations for received communications). The communication is then received by user B. The communication can be translated (e.g., by the jargon translation structure 320 of the communication enabler structure 315 of user communication device B) in accordance with i.) user B's “receiving” jargon translation policies (e.g., special shorthand that user B prefers), ii.) additional operator A “receiving” jargon translation policies (e.g., special translations that operator B provides to users), and/or iii.) additional general purpose shared “receiving” jargon translation policies (e.g., commonly accepted translations). The jargon translated communication can then be delivered to user B. Accordingly, the distributed jargon translation according to an alternative exemplary embodiments of the present invention can be performed at suitable points along the communication path between users.

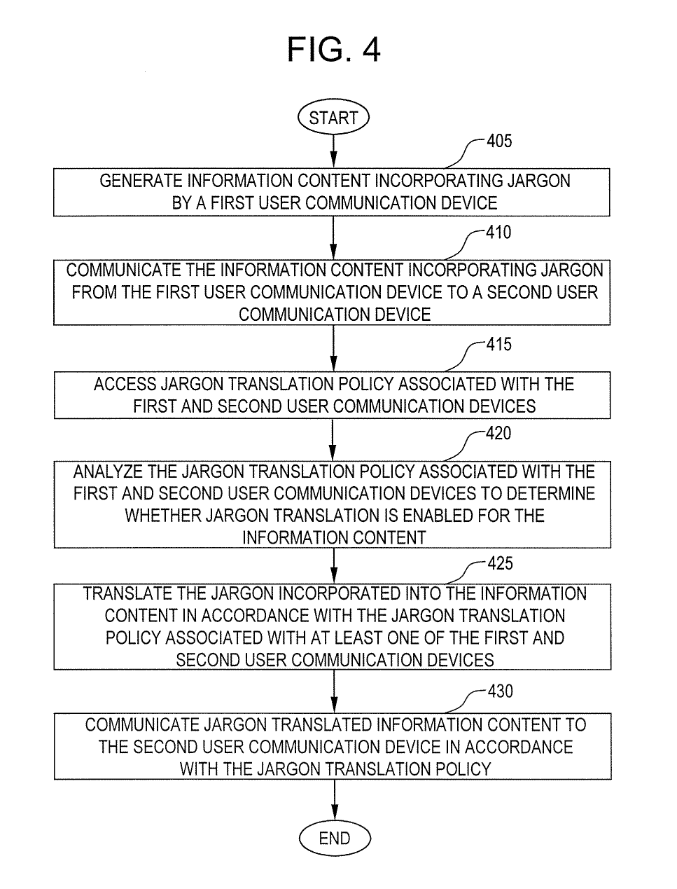

FIG. 4 is a flowchart illustrating steps for communicating information content incorporating jargon, in accordance with an exemplary embodiment of the present invention. In step 405, information content incorporating jargon is generated by a first user communication device. In step 410, the information content incorporating jargon is communicated from the first user communication device to a second user communication device. In step 415, jargon translation policy associated with the first and second user communication devices is accessed. In step 420, the jargon translation policy associated with the first and second user communication devices is analyzed to determine whether jargon translation is enabled for the information content. In step 425, the jargon incorporated into the information content is translated in accordance with the jargon translation policy associated with at least one of the first and second user communication devices. In step 430, jargon translated information content is communicated to the second user communication device in accordance with the jargon translation policy.

According to exemplary embodiments, step 425 can be performed when it is determined that jargon translation is enabled in accordance with the jargon translation policy. For example, if it is determined that jargon translation is not enabled, the information content incorporating jargon would be communicated to the second user communication device without such translation. Additionally, the method can include one or more of the following steps: managing the jargon translation policy associated with each of the first and second user communication devices; managing jargon translation preferences of users; and storing jargon translation information. According to an alternative exemplary embodiment, information content without jargon can be communicated from the first user communication device to the second user communication device. All or any portion of the information content can be translated into jargon in accordance with the jargon translation policy associated with at least one of the first and second user communication devices.

Each, all or any combination of the steps of a computer program as illustrated in, for example, FIG. 4 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any wireless or wired device, system or process for communicating information. For example, exemplary embodiments can be used in presence- and IM-based communication systems, such as in mobile and fixed IM systems and the like, to bridge jargon gaps in communication, save keying or inputting for jargon-aware users, and optimize message delivery for jargon-aware users.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and patent applications, foreign patents and patent applications, and publications discussed above are hereby incorporated by reference herein in their entireties to the same extent as if each individual patent, patent application, or publication was specifically and individually indicated to be incorporated by reference in its entirety.

What is claimed is:

1. A system for communicating messages incorporating jargon, comprising:
a communication enabler server module in communication with a plurality of user communication modules,
wherein a first user communication module is configured to communicate a message incorporating jargon to a second user communication module,
wherein the communication enabler server module comprises:
a jargon translation module,
wherein the jargon translation module is configured to translate the jargon incorporated into the message in accordance with jargon translation policy associated with at least one of the first and second user communication modules, and
wherein the communication enabler server module is configured to communicate a jargon translated message to the second user communication module in accordance with the jargon translation policy.

2. The system of claim 1, wherein the communication enabler server module comprises:
a translation policy management module,
wherein the translation policy management module is configured to manage the jargon translation policy associated with each of the first and second user communication modules.

3. The system of claim 2, wherein the jargon translation module is configured to analyze the jargon translation policy associated with the first and second user communication modules to determine whether jargon translation is enabled for the message.

4. The system of claim 3, wherein the jargon translation module is configured to translate the jargon incorporated into the message when it is determined that jargon translation is enabled.

5. The system of claim 2, wherein the translation policy management module is configured to manage jargon translation preferences of users.

6. The system of claim 1, wherein the communication enabler server module comprises:
a storage module,
wherein the storage module is configured to store jargon translation information.

7. The system of claim 1, wherein the communication enabler server module comprises:
a communication module,
wherein the communication module is configured to communicate information with users.

8. The system of claim 1, comprising:
a system administration module in communication with the communication enabler server module,
wherein the system administration module is configured to administer the communication enabler server module.

9. The system of claim 1, wherein the first user communication module is configured to communicate a message without jargon to the second user communication module, and
wherein the jargon translation module is configured to translate information in the message into jargon in accordance with the jargon translation policy associated with at least one of the first and second user communication modules.

10. The system of claim 1, wherein the jargon translation module is configured to translate substantially the entire message in accordance with jargon translation policy associated with at least one of the first and second user communication modules.

11. The system of claim 1, wherein the jargon translation module is configured to translate the message in accordance with a destination of the message.

12. An apparatus for managing jargon in messages, comprising:
a user communication device,
wherein the user communication device is adapted to communicate a message incorporating jargon to a second user communication device,
wherein the user communication device comprises:
communication enabler structure,
wherein the communication enabler structure comprises:
jargon translation structure,
wherein the jargon translation structure is adapted to translate the jargon incorporated into the message in accordance with jargon translation policy associated with at least one of the user communication device and the second user communication device, and
wherein the communication enabler structure is adapted to communicate a jargon translated message to the second user communication device in accordance with the jargon translation policy.

13. The apparatus of claim 12, wherein the communication enabler structure comprises:
translation policy management structure,
wherein the translation policy management structure is adapted to manage the jargon translation policy associated with each of the first and second user communication devices.

14. The apparatus of claim 13, wherein the jargon translation structure is adapted to analyze the jargon translation policy associated with the first and second user communication devices to determine whether jargon translation is enabled for the message.

15. The apparatus of claim 12, wherein the jargon translation structure is adapted to translate the jargon incorporated into the message when it is determined that jargon translation is enabled.

16. The apparatus of claim 13, wherein the translation policy management structure is adapted to manage jargon translation preferences of users.

17. The apparatus of claim 12, wherein the communication enabler structure comprises:
communication structure,
wherein the communication structure is adapted to communicate information with users.

18. The apparatus of claim 12, wherein the communication enabler structure comprises:
storage structure,
wherein the storage structure is adapted to store jargon translation information.

19. The apparatus of claim 12, comprising:
a system administration server in communication with the communication enabler structure,
wherein the system administration server is adapted to administer the communication enabler structure.

20. The apparatus of claim 12, wherein the first user communication device is adapted to communicate a message without jargon to the second user communication device, and
wherein the jargon translation structure is adapted to translate information in the message into jargon in accordance with the jargon translation policy associated with at least one of the first and second user communication devices.

21. The apparatus of claim 12, wherein the jargon translation structure is adapted to translate substantially the entire message in accordance with jargon translation policy associated with at least one of the user communication devices.

22. The apparatus of claim 12, wherein the jargon translation structure is adapted to translate the message in accordance with a destination of the message.

23. A method of communicating information content incorporating jargon, comprising the steps of:
a.) communicating information content incorporating jargon from a first user communication device to a second user communication device;
b.) translating the jargon incorporated into the information content in accordance with jargon translation policy associated with at least one of the first and second user communication devices; and
c.) communicating jargon translated information content to the second user communication device in accordance with the jargon translation policy.

24. The method of claim 23, comprising the step of:
d.) generating the information content incorporating jargon.

25. The method of claim 23, comprising the step of:
d.) accessing the jargon translation policy associated with the first and second user communication devices.

26. The method of claim 23, comprising the step of:
d.) analyzing the jargon translation policy associated with the first and second user communication devices to determine whether jargon translation is enabled for the information content.

27. The method of claim 23, comprising the step of:
d.) translating the jargon incorporated into the information content when it is determined that jargon translation is enabled in accordance with the jargon translation policy.

28. The method of claim 23, comprising the steps of:
d.) communicating information content without jargon from the first user communication device to the second user communication device; and
e.) translating information in the information content into jargon in accordance with the jargon translation policy associated with at least one of the first and second user communication devices.

29. The method of claim 23, comprising the step of:
d.) managing the jargon translation policy associated with each of the first and second user communication devices.

30. The method of claim 23, comprising the step of:
d.) managing jargon translation preferences of users.

31. The method of claim 23, comprising the step of:
d.) storing jargon translation information.

32. The method of claim 23, wherein step (b) comprises the step of:
d.) translating substantially the entire information content in accordance with jargon translation policy associated with at least one of the first and second user communication devices.

33. The method of claim 23, wherein step (b) comprises the step of:
d.) translating the information content in accordance with a destination of the information content.
